(19) United States
(12) Patent Application Publication
(10) Pub. No.: US 2011/0180640 A1
(43) Pub. Date: Jul. 28, 2011

(54) PAPER EDGE SHREDDING DEVICE

(76) Inventor: Felipe Angel, Laguna Hills, CA (US)

(21) Appl. No.: 12/692,429

(22) Filed: Jan. 22, 2010

(51) Int. Cl. B02C 19/00

(52) U.S. Cl. 241/36

(57) ABSTRACT

A handheld shredding device for distressing edges of paper, stationery and other media includes a tapered slot for receiving the edges. A press button actuates a battery powered shredder disposed along a bottom section of the slot. A trash bin located underneath the shredder is formed within a housing of the device. Doors open to provide access to the bin when the device is substantially upright, and close to prevent collected debris from spilling out when the device is substantially upside down.

### BACKGROUND OF THE INVENTION

1. Field of the Invention

The present invention relates generally to a paper shredding device.

2. Description of Prior Art and Related Information

In the scrapbook and arts-and-crafts industries, do-it-yourself projects include making your own book or journal. To add extra flair to the finished product, edges of the pages of a book or a journal may be distressed to provide an artsy and custom-made appearance. In the past, this was typically done by manually scraping the edges of the paper with a carton knife, a very laborious and time consuming task.

### SUMMARY OF THE INVENTION

The present invention provides structures and methods which overcome the deficiencies in the prior art.

In one aspect, a handheld edge shredding device is provided. The device comprises a housing defining a slot for receiving an edge of a paper or flat media. An electrically powered shredder disposed at a bottom section of the slot is configured to distress the edge when inserted into the slot. A button actuates the shredder when pressed. A top section of the slot is tapered. The top portion of the slot defines a first width of 6 mm at a starting end and a second width of 12 mm at a finishing end. The button is preferably located along a first side of the housing. The shredder comprises a rotatable wheel with teeth.

The device further comprises a trash bin disposed beneath the slot, and a barrier, or gate, that opens by way of gravity when the device is in a generally upright position and closes when the device is generally upside down. The barrier comprises a pair of doors.

The device preferably has a weight less than 3 pounds, a length less than 7 inches, a width less than 4 inches, and a height less than 4 inches.

In another aspect, a handheld edge shredding device comprises a housing defining a slot for receiving an edge of a paper or flat media. An electrically powered shredder is configured to distress the edge when inserted into the slot. A button actuates the shredder when pressed. A trash bin is disposed beneath the slot. A barrier to the bin opens by way of gravity when the device is in a generally upright position and closes when the device is generally upside down. The barrier preferably comprises a pair of doors

A top section of the slot is tapered. The button is located along a first side of the housing. The device preferably has a weight less than 3 pounds, a length less than 7 inches, a width less than 4 inches, and a height less than 4 inches. The shredder comprises a rotatable wheel with teeth.

In a further aspect, a handheld edge shredding device preferably comprises a housing defining a slot for receiving an edge of a paper or flat media, an electrically powered shredder configured to distress the edge when inserted into the slot, a button to actuate the shredder when pressed, a weight less than 3 pounds, a length less than 7 inches, a width less than 4 inches and a height less than 4 inches.

A top section of the slot is tapered. The device further comprises a trash bin disposed beneath the slot, and a barrier that opens by way of gravity when the device is in a generally upright position and closes when the device is generally upside down. The barrier preferably comprises a pair of doors. The shredder comprises a rotatable wheel with teeth.

In a further aspect, a handheld shredding device for distressing edges of paper, stationery and other media includes a tapered slot for receiving the edges. A press button actuates a battery powered shredder disposed along a bottom section of the slot. A trash bin located underneath the shredder is formed within a housing of the device. Doors open to provide access to the bin when the device is substantially upright, and close to prevent collected debris from spilling out when the device is substantially upside down.

The invention, now having been briefly summarized, may be better appreciated by the following detailed description.

### BRIEF DESCRIPTION OF THE DRAWINGS

FIG. 1 is a top perspective view of a preferred embodiment of a handheld edge shredding device;

FIG. 2 is a top perspective view of the preferred embodiment of the shredding device with a top cover removed to reveal the internal structure of the device;

FIG. 3 is another top perspective view of the preferred embodiment of the shredding device with a top cover removed to reveal the internal structure of the device;

FIG. 4 is an exploded view of the preferred embodiment of the shredding device;

FIG. 5 is a top lan view of the preferred embodiment of the shredding device;

FIG. 6 is a bottom perspective view of a preferred opening to a trash bin when the device is in an upright position;

FIG. 7 is a bottom perspective view of the preferred opening to the trash bin when the device is upside down;

FIGS. 8-1 to 8-5 illustrate operative views of the preferred shredding device; and

FIG. 9 illustrates a preferred method of shredding an edge of media.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

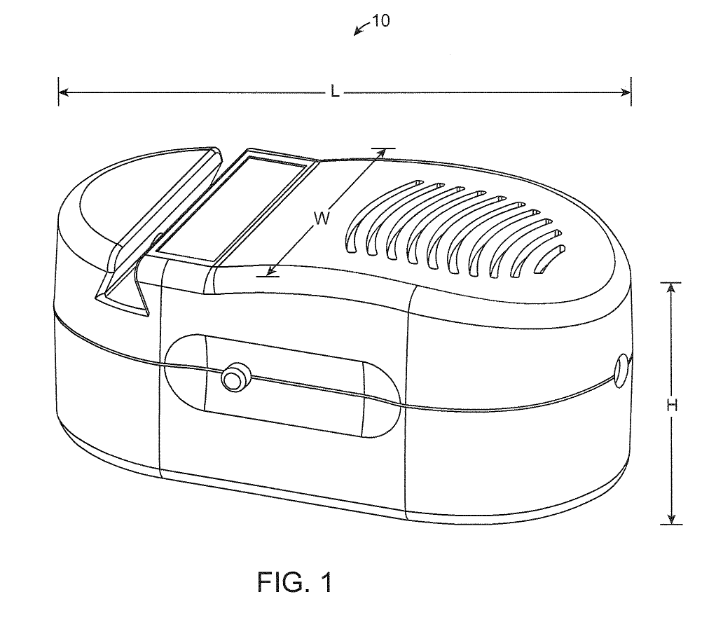

FIG. 1 is a perspective view of a preferred embodiment of a handheld edge shredding device 10 for shredding, or distressing, the edges of paper and other generally flat media. The device 10 preferably defines a length “L” less than 7 inches, a width “W” less than 4 inches and a height “H” less than 4 inches. The device preferably weighs less than 3 pounds. For example, the preferred embodiment 10 may weigh approximately 1 pound and define a length of 5.25 inches, a width of 2.75 inches and a height of 2.25 inches. Thus, the preferred device 10 is small and light enough to be held in one hand. The preferred device 10 also comprises a flat bottom surface 20 such that the device 10 may be used on top of a flat surface such as a table or floor.

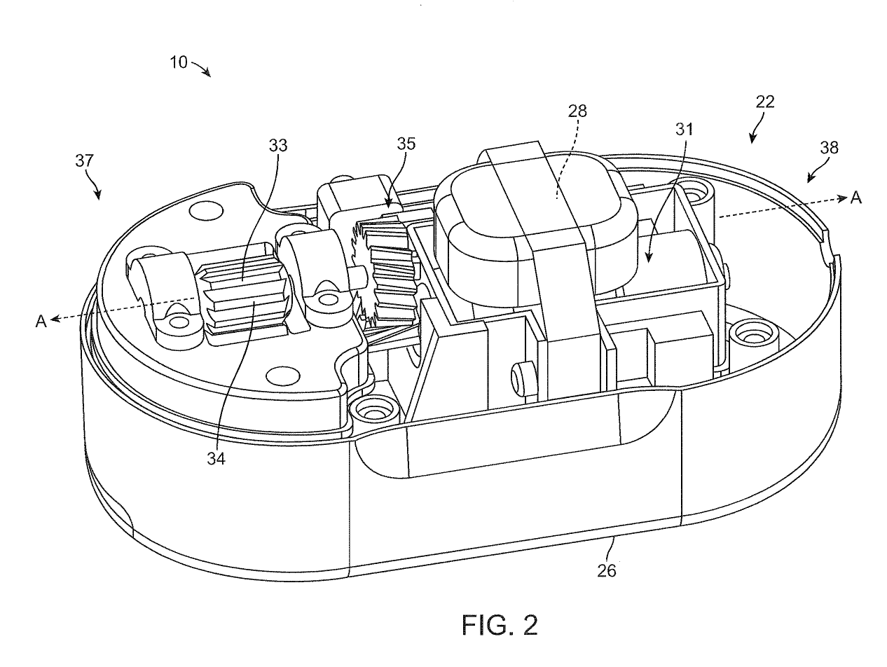

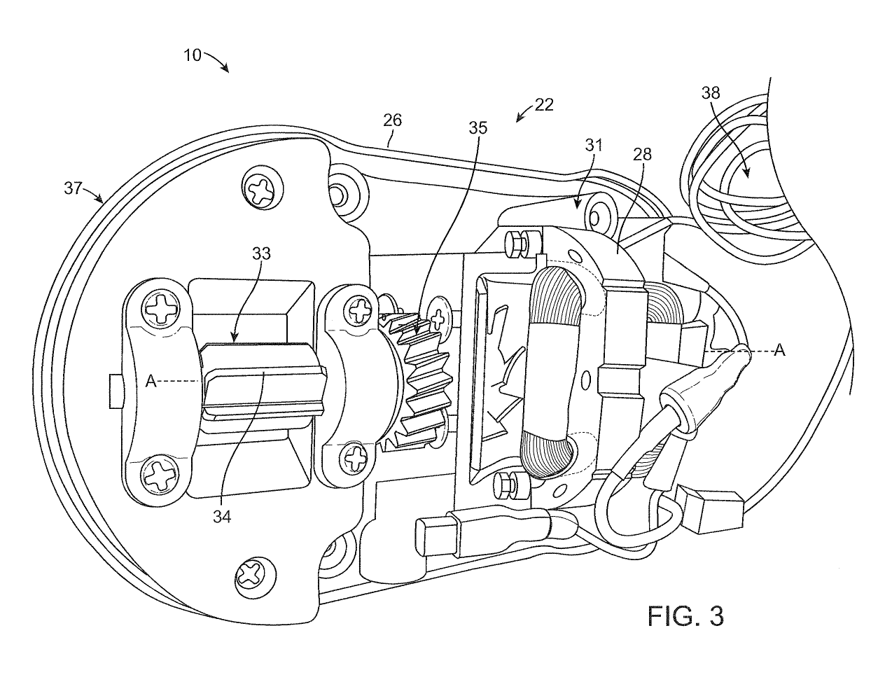

In FIGS. 2 and 3, the preferred device 10 comprises a housing 22 including a top portion 24 (removed) and a bottom portion 26 configured to be coupled together. Enclosed within the housing 22 is a power source 28, such as a battery. The preferred device 10 may also omit the battery and instead comprise a motor 31, such as 110V motor, that is electrically charged by a standard plug. The motor 31 drives a distressing mechanism, or shredder, 33 through a series of gears 35. The shredder 33 preferably comprises a rotatable wheel configured to rotate about an axis “A” defined between a front end 37 and back end 38 of the device 10. Teeth 34 are formed radially on the shredder 33.

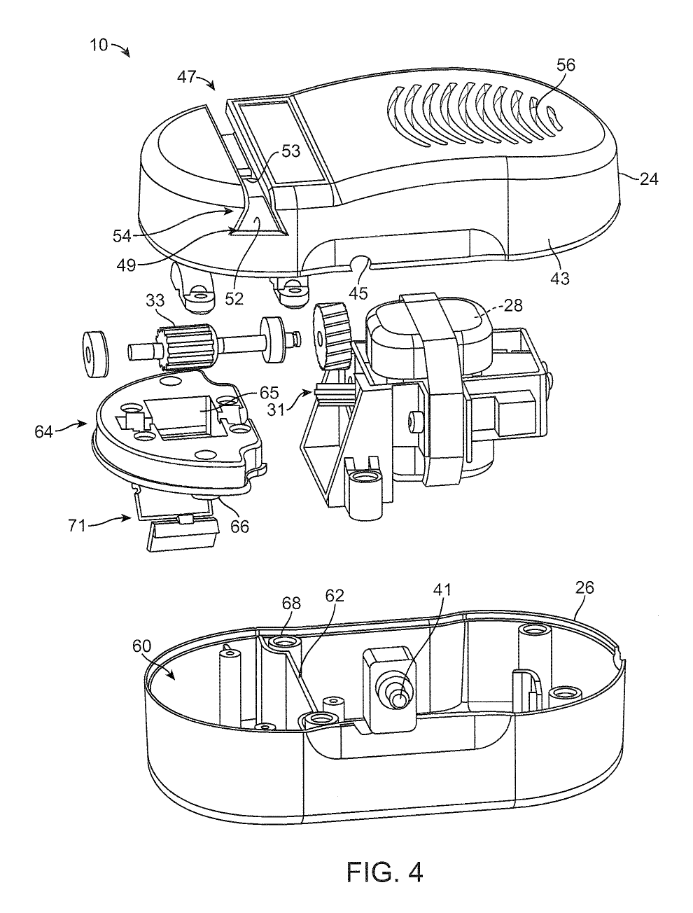

In FIG. 4, a press button 41 is configured to operate the motor 31 and thus rotate the shredder 33. In the preferred embodiment, the shredder 33 operates only when the button 41 is pressed, and therefore ceases when the button 41 is released. The press button 41 is preferably located on a side 43 of the housing 22 and protrudes laterally through a side hole 45.

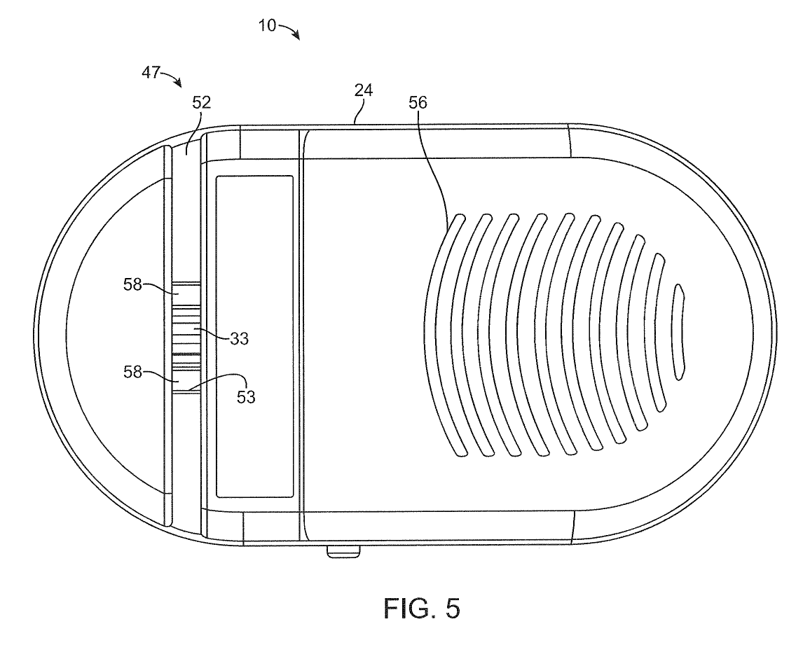

In FIGS. 4 and 5, a transverse slot 47 is defined in the top housing portion 24 and configured to receive the edge of media to be distressed, such as paper. The shredder 33 is disposed adjacent to a bottom section 49 of the slot 47 and protrudes slightly above a floor 52 so as to engage the media when inserted through the slot 47. The shredder 33 thus rotates in line with the length of the slot 47. The floor 52 defines an aperture 53 through which a portion of the shredder 33 is disposed. The aperture 53 is sized large enough to provide gaps 58, shown in FIG. 5, on both sides of the shredder 33 through which shredded bits of media may fall.

As shown more clearly in FIG. 4, a top section 54 of the slot 47 is tapered. Alternatively stated, the bottom slot section 49 is widened so as to accommodate the edges of the media which fatten when distressed. In the preferred embodiment, the bottom slot section 49 may be 1 mm to 10 mm wider than the top slot section 54. As an example and not by way of limitation, the width of the top slot section may be 6 mm while the width of the bottom slot section may be 12 mm. Thus, the slot 47 may receive a single sheet of paper, a thin stack of paper, or other media thicker than paper. Since the device 10 is preferably battery operated, vent holes 56 are formed in the top housing portion 24 generally above the location of the battery 28 to facilitate release of heat.

In FIG. 4, the device 10 also comprises a trash bin 60 disposed beneath the slot 47 for collecting debris and shredded bits of media. In the preferred embodiment, the trash bin 60 comprises a reservoir defined in the bottom housing portion 26. A vertical wall 62 further defines the bin 60 and helps keep the debris enclosed and segregated from the rest of the bottom housing portion 26.

A removable bin cover, or lid, 64 is configured to be disposed between the slot 47 and the bin 60. The cover 64 comprises tabs 66 that removably mate with corresponding grooves 68 defined in the bottom wall portion 26. The cover 64 defines an opening 68 disposed beneath the shredder 33. A barrier, or gate, 71 opens as to provide communication to the bin 60 and closes to seal the bin 60.

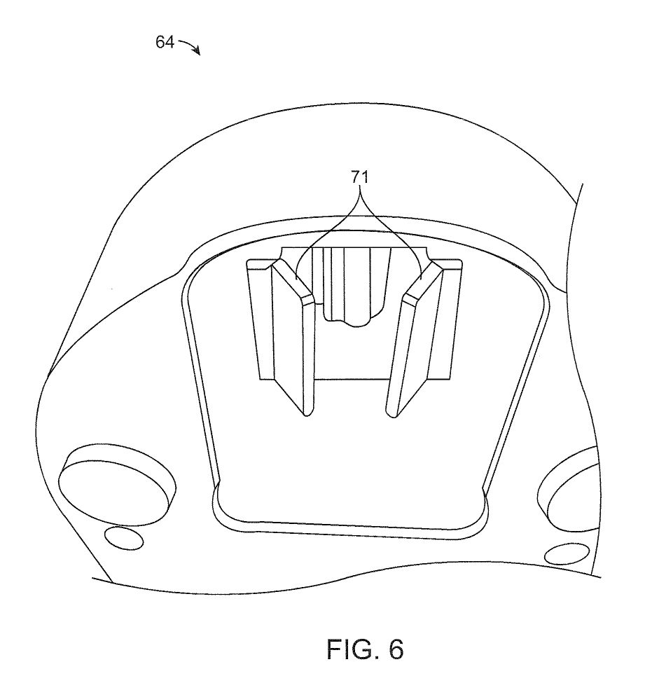

In the preferred embodiment as shown in FIG. 6, the barrier 71 of the cover 64 comprises a pair of doors hinged at outer ends which open (e.g., rotate) by way of gravity when the device 10 is in a generally upright, or right side up, position. This provides access through the opening 68 to the bin 60 beneath. Therefore, when the device 10 is being operated in an upright position (e.g., when placed on a desktop or held in such a position), the open doors 71 enable shredded debris to fall into the bin by way of gravity.

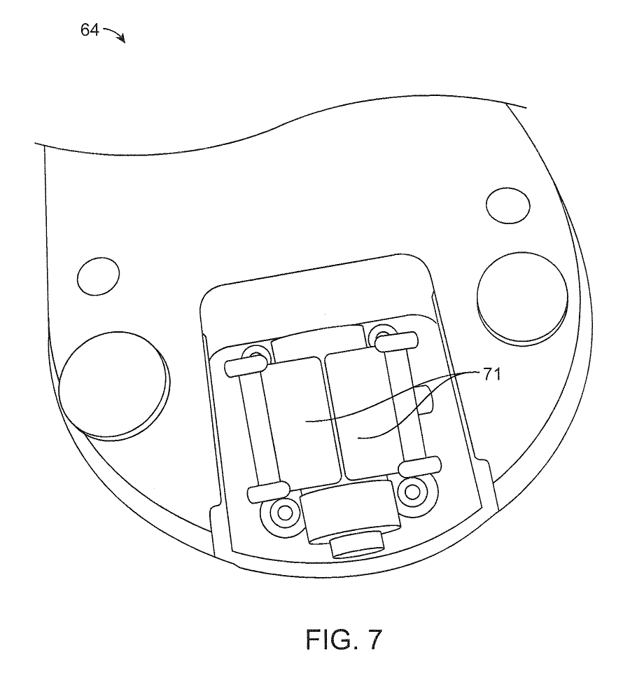

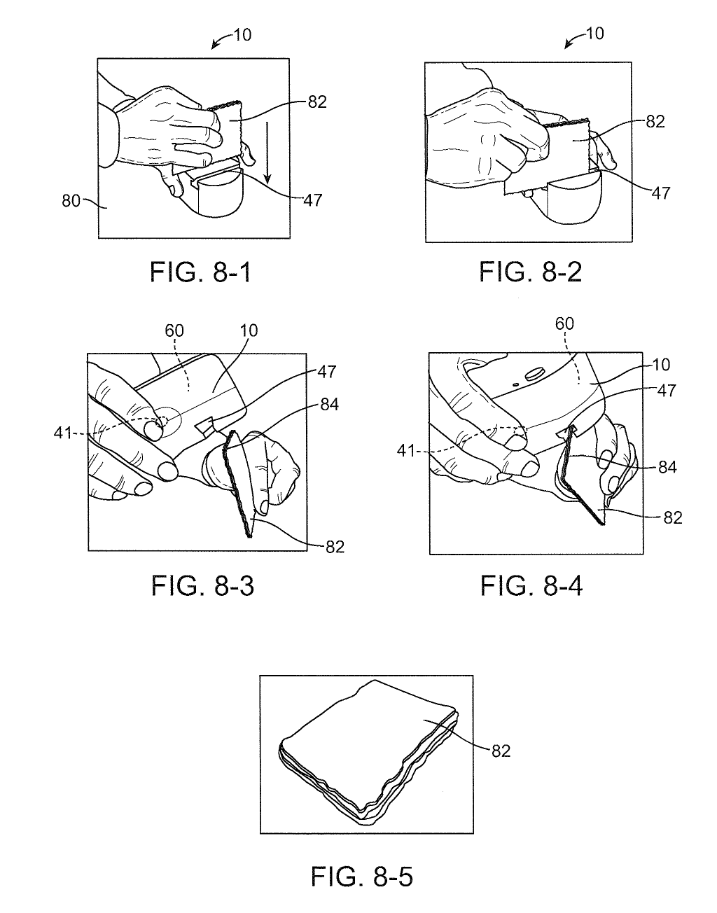

Since the device 10 is small and light enough to be handheld, the device 10 is also configured to be operated when upside down as shown in FIG. 8. Accordingly, the doors 71 rotate by way of gravity to close the opening 68 when the device 10 is generally upside down as shown in FIG. 7. This prevents the contents in the bin 60 from spilling out as the device 10 is held upside down.

FIGS. 8-1 to 8-5 illustrate operative views of the device 10.

In FIGS. 8-1 to 8-2, the device 10 may be placed on top of a horizontal surface 80, such as a table, and operated in an upright position. A user may insert a stack of media 82, such as paper, into the slot 47 vertically (from the top down) as shown in FIG. 8-1, or horizontally as shown in FIG. 8-2.

The device 10 may also be held in the user's hand and operated upside down, as shown in FIGS. 8-3 to 8-4, or in any other position. A user may insert the media 82 into the downward facing slot 47, or bring the device 10 toward the media 82 such that the slot 47 receives the top edges 84. It will be appreciated that in this generally upside down position, any debris in the bin 60 within the housing 22 is contained and prevented from spilling as discussed above in connection with FIGS. 6 and 7. It will be further appreciated that the convenient location of the press button 41 on the side 43 of the device 10 enables the user to actuate the shredder with a single finger, such as with an index finger or thumb, while holding the device 10. In other words, a second hand is not required to actuate the shredder.

FIG. 8-5 illustrates finished media 82, e.g., a stack of paper, where each of the four edges of the media are distressed using the preferred embodiments described above.

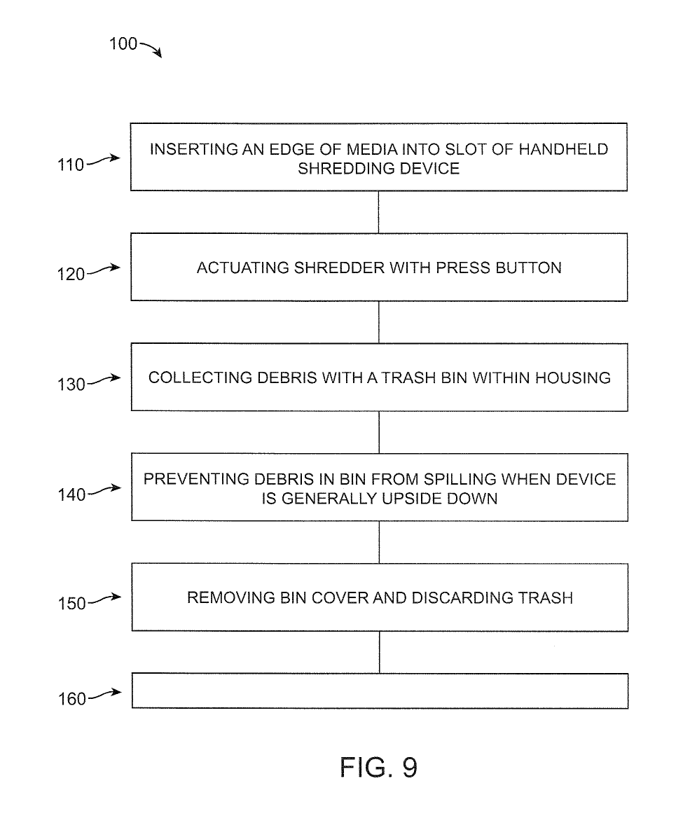

In FIG. 9, it will be appreciated that a preferred method 100 of distressing edges of media is provided. Step 110 comprises inserting an edge of media into the transverse slot of a preferred embodiment of a handheld shredding device. Step 110 may also comprise holding the preferred device in a user's hand and bringing the device toward the edge of the media such that the slot receives the edge. Accordingly, step 110 comprises holding the device in any position, including an upside down position, and engaging the media in any position.

In step 120, the shredder is actuated by pressing a button, preferably located on a side of the device 10. In the preferred method, the shredder is actuated only when the user keeps the button pressed and is therefore stopped when the button is released. Step 120 preferably comprises pressing the button with a finger of thumb of the same hand holding the device. Since the device is preferably battery operated, step 120 comprises actuating the shredder using electrical power.

Step 130 comprises collecting debris with a trash bin located within the housing. In particular, step 130 comprises capturing shredded debris that fall into gaps formed adjacent to the shredder when the device is operated in a generally upright position.

In step 140, any debris in the trash bin is prevented from spilling when the device is generally upside down or in any position substantially off from an upright position. Step 140 comprises blocking an opening to the bin by, for example, doors which open and close by way of gravity.

Step 150 comprises discarding trash in the bin. In the preferred method, step 150 comprises removing a top housing portion initially and then a cover to the bin to access the contents of the bin. After the trash is discarded, a cover is placed back on top of the bin, and the top housing portion is coupled to a bottom housing portion.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

1. A handheld edge shredding device, comprising:
a housing defining a slot for receiving an edge of a paper or flat media;
an electrically powered shredder configured to distress the edge when inserted into the slot; and
a button to actuate the shredder when pressed.

2. The device of claim 1, wherein:
a top section of the slot is tapered.

3. The device of claim 2, wherein a bottom section of the slot is wider than the top section of the slot in the range of 2 mm to 10 mm.

4. The device of claim 1, wherein the button is located along a first side of the housing.

5. The device of claim 1, further comprising:
a trash bin disposed beneath the slot; and
a barrier that opens by way of gravity when the device is in a generally upright position and closes when the device is generally upside down.

6. The device of claim 5, wherein the barrier comprises a pair of doors.

7. The device of claim 1, wherein the device has a weight less than 3 pounds.

8. The device of claim 1, wherein the device comprises:
a length less than 7 inches;
a width less than 4 inches; and
a height less than 4 inches.

9. The device of claim 1, wherein the shredder comprises a rotatable wheel with teeth.

10. A handheld edge shredding device, comprising:
a housing defining a slot for receiving an edge of a paper or flat media;
an electrically powered shredder configured to distress the edge when inserted into the slot;
a button to actuate the shredder when pressed;
a trash bin disposed beneath the slot; and
a barrier that opens by way of gravity when the device is in a generally upright position and closes when the device is generally upside down.

11. The device of claim 10, wherein:
a top section of the slot is tapered.

12. The device of claim 10, wherein the button is located along a first side of the housing.

13. The device of claim 10, wherein the barrier comprises a pair of doors.

14. The device of claim 10, wherein the device has a weight less than 3 pounds.

15. The device of claim 10, wherein the device comprises:
a length less than 7 inches;
a width less than 4 inches; and
a height less than 4 inches.

16. The device of claim 10, wherein the shredder comprises a rotatable wheel with teeth.

17. A handheld edge shredding device, comprising:
a housing defining a slot for receiving an edge of a paper or flat media;
an electrically powered shredder configured to distress the edge when inserted into the slot;
a button to actuate the shredder when pressed;
a weight less than 3 pounds;
a length less than 7 inches;
a width less than 4 inches; and
a height less than 4 inches.

18. The device of claim 17, wherein a top section of the slot is tapered.

19. The device of claim 17, further comprising:
a trash bin disposed beneath the slot; and
a barrier that opens by way of gravity when the device is in a generally upright position and closes when the device is generally upside down.

20. The device of claim 17, wherein the barrier comprises a pair of doors.

21. The device of claim 17, wherein the shredder comprises a rotatable wheel with teeth.
